(19) United States
(12) Patent Application Publication
(10) Pub. No.: US 2024/0394709 A1
(43) Pub. Date: Nov. 28, 2024

(54) UNMANNED PAYMENT PROCESSING SYSTEM FOR PROCESSING PAYMENT BY USING TOKENS AND TRANSACTION APPROVAL SYSTEM INCLUDING SAME

(71) Applicant: TRICUBICSKOREA CO., LTD., Daegu (KR)

(72) Inventor: Min Jong Kim, Daegu (KR)

(73) Assignee: TRICUBICSKOREA CO., LTD., Daegu (KR)

(21) Appl. No.: 18/568,093

(22) PCT Filed: Jun. 7, 2022
(86) PCT No.: PCT/KR2022/007985

§ 371 Date: Jul. 3, 2024

(30) Foreign Application Priority Data
Jun. 7, 2021 (KR) 10-2021-0073186

(51) Int. Cl. G06Q 20/40; G06Q 20/18

(52) U.S. Cl. CPC G06Q 20/4014; G06Q 20/18

(57) ABSTRACT

The present invention relates to: an unmanned payment processing system that can process payment even without a prior customer registration procedure or a prepayment procedure by using transaction tokens; and a transaction approval system including same.

### TECHNICAL FIELD

The present invention relates to an unmanned payment processing system for processing a payment using a token and a transaction approval system including the same, and more particularly, technology that may process a payment without a prior customer registration procedure or a prepayment procedure using a transaction token.

### RELATED ART

The Fourth Industrial Revolution, which has been recently in the spotlight, includes representative keywords, such as bigdata, Internet of things (IoT), artificial intelligence (AI), and deep learning. Technology of the Fourth Industrial Revolution may have a direct impact on our daily lives and is evolving through learning and analysis beyond becoming a convenient tool in our lives.

With such technological developments, interest in offline shopping with the Fourth Industrial Revolution applied is recently increasing.

In response to this technological change, Amazon opened a new offline mart, ‘Amazon Go.’ Amazon Go is not much different from regular supermarkets that sell groceries and miscellaneous goods. Here, a user of Amazon Go does not need to perform a separate calculation after selecting a product. Amazon Go automatically recognizes the product selected by the user and charges a payment for the recognized product using a payment method corresponding to the user.

However, the existing Amazon had the limitation of charging only a user pre-registered to a site, such as amazon go, to pay for a product using a payment method corresponding to the user.

### DETAILED DESCRIPTION

### Technical Subject

An objective of the present invention is to request a payment for a confirmed transaction amount according to a user's product purchase using a transaction token even without a prior user registration procedure.

### Technical Solution

According to an example embodiment, there is provided an unmanned payment processing system to communicate with a transaction terminal, the unmanned payment processing system including a receiving unit configured to receive, from the transaction terminal, payment method information and transaction information verified and approved by a payment agency server and a transaction token issued from the payment agency server; a transaction information providing unit configured to provide, to the transaction terminal, the transaction information of a confirmed transaction amount according to a product purchase of a user; and a processing unit configured to process a payment by combining the transaction information with the transaction token.

The receiving unit may be configured to request the transaction terminal for the transaction token issued from the payment agency server with a validity verification result for the payment method information.

The receiving unit may be configured to receive, from the transaction terminal, the transaction token issued from the payment agency server with the validity verification result for the payment method information verified by the payment agency server and to receive, from the transaction terminal, a transaction approval result for the transaction information approved by a card company server.

The transaction information providing unit may be configured to transmit, to the transaction terminal, the transaction information of a total transaction amount confirmed due to the purchase product of the user in an unmanned store associated with the transaction terminal with the transaction token.

The transaction information providing unit may be configured to verify an adult status through information of the transaction token and, when a product purchased by the user in the unmanned store associated with the transaction terminal is a product allowed to be purchased only by an adult, control provision of the transaction information depending on a selling status.

The processing unit may be configured to process a final payment, re-approval, cancelation of approval, or a partial payment for the approved transaction information based on the transaction approval result of the transaction information by the card company server.

The processing unit may be configured to invalidate un unattended payment processing by managing a rejected user according to a validity verification result for the payment method information.

According to an example embodiment, there is provided a transaction approval system including a transaction terminal configured to receive payment method information and transaction information from a user, to transmit the same to a payment agency server, and to transmit a transaction token issued from the payment agency server, a verification result, and an approval result to an unmanned payment processing system; the payment agency server configured to perform validity verification for the payment method information, to issue the transaction token, and to request a card company server for approving a transaction that matches the transaction token; and the unmanned payment processing system configured to receive, from the transaction terminal, the transaction token with the payment method information and the transaction information verified and approved by the payment agency server and to process a payment.

The transaction terminal may be configured to receive the payment method information by a credit card of the user, to request the payment agency server for the validity verification, and to transmit a validity verification result and the transaction token to the unmanned payment processing system.

The transaction terminal may be configured to receive the transaction information of a confirmed transaction amount from the unmanned payment processing system, to transmit the transaction information and the transaction token to the payment agency server, to receive a transaction approval result from the payment agency server, and to transmit the same to the unmanned payment processing system.

The payment agency server may be configured to transmit the transaction information and the transaction token to the card company server to request approval of a transaction that matches the transaction token and to transmit the transaction approval result from the card company server to the transaction terminal.

The unmanned payment processing system may be configured to process a final payment, re-approval, cancelation of approval, or a partial payment for the approved transaction information based on a validity verification result for the payment method information and a transaction approval result of the transaction information by the card company server.

According to an example embodiment, there is provided a transaction approval method of a transaction approval system by a transaction terminal, an unmanned payment processing system, and a payment agency server, the transaction approval method including transmitting, by the transaction terminal, payment method information input from a user; performing, by the payment agency server, validity verification for the payment method information received from the transaction terminal and issuing a transaction token; confirming, by the unmanned payment processing system, transaction information that includes a payment amount according to a product purchase of the user; and processing, by the unmanned payment processing system, a payment for the transaction information based on an approval result for the transaction information by a card company server.

The issuing of the transaction token may include transmitting a validity verification result for the payment method information and the transaction token to the unmanned payment processing system through the transaction terminal.

The confirming of the transaction information may include combining the transaction information of a transaction amount confirmed due to a product purchase of the user with the transaction token and transmitting the same to the payment agency server through the transaction terminal.

The confirming of the transaction information may include requesting, by the payment agency server, the card company server for approving the transaction information that matches a transaction token value.

The processing of the payment may include processing, by the unmanned payment processing system, a final payment, re-approval, cancelation of approval, or a partial payment for the approved transaction information based on the approval result for the transaction information from the card company server.

### Effect of Invention

According to some example embodiments, it is possible to request a payment for a confirmed transaction amount according to a user's product purchase without a separate need to scan a card after pre-authentication using a transaction token.

Also, according to some example embodiments, when unspecific multiple users purchase products in an offline store or an unmanned vending machine, an automatic payment service may be provided without a payment action for a product purchase, a final payment action after a provisional payment, or a payment action after registration as a member.

### BRIEF DESCRIPTION OF DRAWINGS

FIG. 1 illustrates a configuration of a transaction approval system according to an example embodiment.

FIG. 2 is a block diagram illustrating a detailed configuration of an unmanned payment processing system according to an example embodiment.

FIG. 3 illustrates a transaction approval process among a transaction terminal, an unmanned payment processing system, a payment agency server, and a card company server according to an example embodiment.

### BEST MODE

Advantages and features of the present invention and methods of achieving the same will become clear with reference to example embodiments described in detail with the accompanying drawings. However, the present invention is not construed as being limited to the example embodiments disclosed below and will be implemented in various forms different from each other. The example embodiments are provided to make the disclosure of the present invention complete and to inform the scope of the present invention to one of ordinary skill in the art to which the present invention pertains and the present invention is only defined by the scope of the claims.

The terminology used herein is for the purpose of describing the example embodiments only and is not to be limiting the present invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated components steps, operations, and/or elements, but do not preclude the presence or addition of one or more other components, steps, operations, and/or elements.

Unless otherwise defined herein, all terms used herein (including technical or scientific terms) have the same meanings as those generally understood by one of ordinary skill in the art. Also, terms defined in dictionaries generally used should be construed to have meanings matching contextual meanings in the related art and are not to be construed as an ideal or excessively formal meaning unless otherwise defined herein.

Hereinafter, example embodiments of the present invention will be described in detail with reference to the accompanying drawings. Like reference numerals refer to like components throughout and repeated description related thereto will be omitted.

A transaction approval system according to an example embodiment may recognize some information by a user's simple action of scanning a card and authenticate the same by issuing a token, and when the user purchases a product, may automatically recognize purchase of the product and firmly determine a payment amount and then, make a payment by adding the payment amount to token information.

Also, a transaction approval system according to an example embodiment may provide a method of recognizing a user using a transaction token, a method of encrypting and storing authenticated information, a method of performing a payment later using a token, a method of performing re-approval, cancelation of approval, or a partial payment when a payment is incorrect, and a method of managing a user who exceeds the limit after authentication.

### MODE

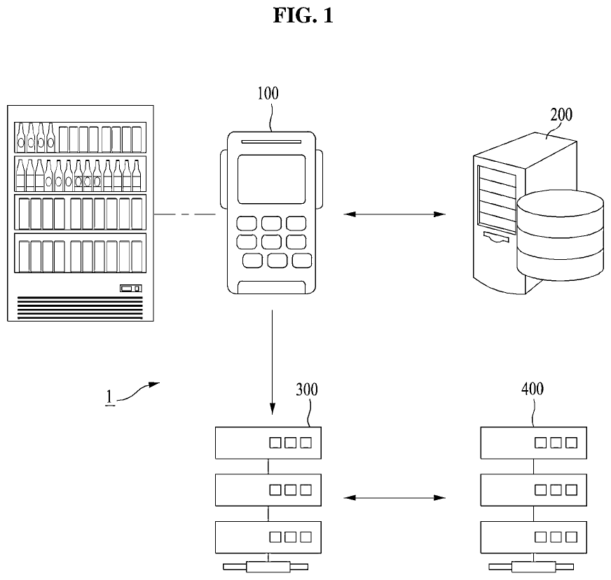

Hereinafter, the aforementioned system and method according to example embodiments are further described with reference to FIGS. 1 to 3.

FIG. 1 illustrates a configuration of a transaction approval system according to an example embodiment.

Referring to FIG. 1, a transaction approval system 1 includes a transaction terminal 100, an unmanned payment processing system 200, a payment agency server 300, and a card company server 400. According to example embodiments, of the transaction approval system 10, the transaction terminal 100 may be installed in an unmanned selling machine such as an unmanned vending machine or an unmanned refrigerator in an offline store, or may be installed in a space such as an unmanned store. Also, the unmanned payment processing system 200 may be located in the unmanned store and may perform a role of a management server that manages the unmanned vending machine and the unmanned store and may perform a process of recognizing and determining a process of a user entering the unmanned store and selecting a product at the unmanned vending machine and calculating a total payment amount for the purchased product. Also, the payment agency server 300 and the card company server 400 are present outside the unmanned store.

However, without being limited thereto, a transaction terminal, an unmanned payment processing system, a payment agency server, and a card company server may be separately installed in different spaces. Also, the transaction approval system 1 may be applied in various offline environments, for example, an unmanned restaurant, an unmanned vehicle, and an unmanned transportation as well as the unmanned vending machine or the unmanned store.

The transaction terminal 100 receives payment method information and transaction information from a user and transmits the same to the payment agency server 300, and transmits a transaction token issued from the payment agency server 300, a verification result, and an approval result to the unmanned payment processing system 200. The transaction token refers to a token assigned to a card of which validity is verified, such as whether a credit card or a check card is stolen, lost, or forged or altered and information that does not contain personal information of a customer.

In detail, the user may enter payment method information by inserting or scanning a credit card, a check card, or a prepaid card into the transaction terminal 100 to use the unmanned vending machine or the unmanned store. The payment method information represents card transaction information in which an amount is excluded from card information of the entered credit card, check card, or prepaid card. The transaction terminal 100 may encrypt the payment method information. Then, the transaction terminal 100 may transmit the encrypted payment method information to the payment agency server 300, may receive, from the payment agency server 300, the transaction token issued with a validity verification result for the payment method information, and may transmit the same to the unmanned payment processing system 200.

Also, the transaction terminal 100 may receive transaction information of a confirmed transaction amount from the unmanned payment processing system 200, may transmit the transaction information and the transaction token to the payment agency server 300, may receive a transaction approval result from the payment agency server 300, and may transmit the same to the unmanned payment processing system 200.

Here, the transaction terminal 100 includes a kiosk terminal, but without being limited thereto, may be any terminal capable of reading card information.

The payment agency server 300 performs validity verification for the payment method information, issues the transaction token, and requests the card company server 400 for approving a transaction that matches the transaction token. Here, the payment agency server 300 may be a value added network (VAN).

The payment agency server 300 may decrypt code of the encrypted transaction terminal 100, may verify validity of the payment method information, and then may issue and store the transaction token. Also, the payment agency server 300 may transmit the transaction information and the transaction token to the card company server 400 to request approval for the transaction that matches the transaction token and may transmit a transaction approval result received from the card company server 400 to the transaction terminal 100. Here, the card company server 400 may represent a corresponding card company server of the credit card, the check card, or the prepaid card entered into the transaction terminal 100.

The unmanned payment processing system 200 may receive, from the transaction terminal 100, the transaction token with the payment method information and the transaction information verified and approved by the payment agency server 300.

The unmanned payment processing system 200 may receive the validity verification result for the payment method information from the payment agency server 300 and the transaction terminal 100, and may read, manage, and store the received transaction token. Then, the unmanned payment processing system 200 may combine transaction information of a final payment amount according to the product purchase of the user with the transaction token and transmit the same back to the payment agency server 300 through the transaction terminal 100, and may process and manage a final payment, re-approval, cancellation of approval, and a partial payment for the approved transaction information based on an approval result of the card company server 400 through the payment agency server 300.

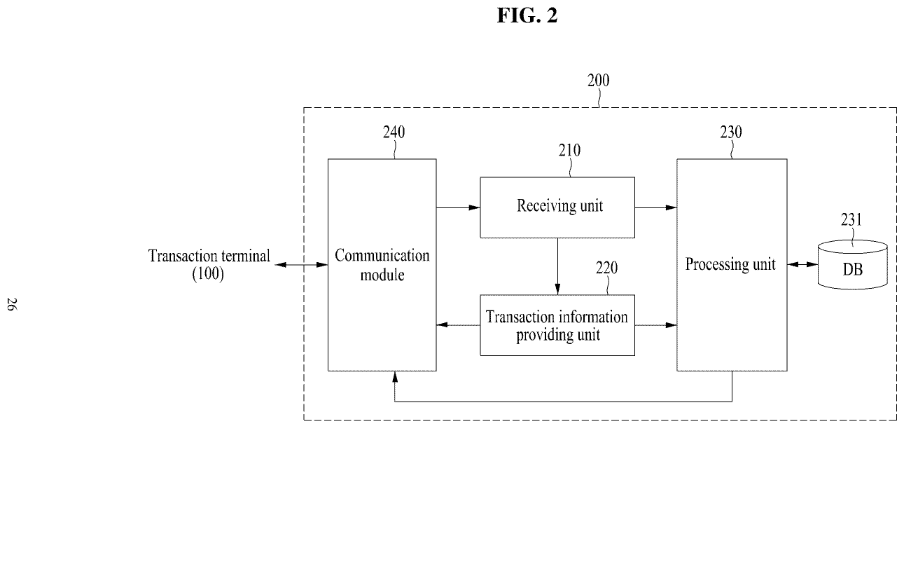

FIG. 2 is a block diagram illustrating a detailed configuration of an unmanned payment processing system according to an example embodiment.

Referring to FIG. 2, the unmanned payment processing system 200 according to an example embodiment receives a validity verification result for payment method information and a transaction approval result through communication with a transaction terminal, reads, manages and stores a transaction token, and processes a payment.

To this end, an unmanned payment processing system 200 according to an example embodiment includes a receiving unit 210, a transaction information providing unit 220, and a processing unit 230, and may further include a database 231 and a communication module 240.

The receiving unit 210 receives, from the transaction terminal 100, a transaction token with payment method information and transaction information verified and approved by a payment agency server.

Before receiving, from the transaction terminal 100, the transaction token with the payment method information and the transaction information verified and approved by the payment agency server, the receiving unit 210 may request the transaction terminal 100 for the transaction token issued from the payment agency server with a validity verification result for the payment method information through the communication module 240.

Then, the receiving unit 210 may receive, from the transaction terminal 100 through the communication module 240, the transaction token issued from the payment agency server with the validity verification result for the payment method information verified by the payment agency server. Also, the receiving unit 210 may receive, from the transaction terminal 100 through the communication module 240, the transaction approval result for the transaction information approved by the payment agency server.

The transaction information providing unit 220 provides transaction information of a confirmed transaction amount according to product purchase of the user to the transaction terminal 100.

For example, when the user receives a validity verification result of payment method information on a card entered by the user into the transaction terminal 100 through the receiving unit 210 and then selects a product in an unmanned vending machine or an unmanned store, the unmanned payment processing system 200 according to an example embodiment may generate transaction information of a total transaction amount according to the product purchase. Then, the transaction information providing unit 220 may combine transaction information of a total transaction amount confirmed due to the product purchase of the user in the unmanned vending machine or the unmanned store associated with the transaction terminal 100 with the transaction token and may transmit the same to the transaction terminal 100 through the communication module 240. Here, the transaction information may include a request for a “final payment” for the total payment amount according to the product purchase of the user and may include a request for re-approval, cancellation of approval, or a partial payment for the purchased product in addition to the final payment.

Also, the transaction information providing unit 220 may store and manage the transaction token received through the receiving unit 210 in the database 231 through the processing unit 230 and may manage and match the transaction token and the product purchase of the user regardless of product purchase order of the user.

Also, the transaction information providing unit 220 may receive an adult status by the transaction token received through the receiving unit 210 and of which validity is checked by the payment agency server, may verify the adult status through information of the transaction token, and when the product purchased by the user in the unmanned store associated with the transaction terminal 100 is a product allowed to be purchased only by an adult, may control provision of the transaction information depending on a selling status.

For example, the transaction token according to the validity verification result determined by the payment agency server may include the adult status by payment method information, that is, credit card or check card information, of the user. Only when the user is determined as an adult based on information of the transaction token, the transaction information providing unit 220 may control a selling status by detecting purchase of a product such as alcohol and cigarettes and by managing and matching the transaction token and the product purchase of the user.

The processing unit 230 performs a payment by combining transaction information with the transaction token.

The processing unit 230 may manage a final payment, reapproval, cancellation of approval, or a partial payment for the approved transaction information based on the transaction approval result for the transaction information.

Therefore, the processing unit 230 may store and manage a processing result in the database 231, and may combine the payment method information and the transaction information with information on the transaction token and may store and maintain the same in the database 231. Also, the processing unit 230 may encrypt information authenticated by the payment agency server and the card company server and may store and maintain the encrypted information in the database 231 with the payment method information encrypted by the transaction terminal 100.

Also, the processing unit 230 may store and manage the transaction token received through the receiving unit 210, in the database 231, and may manage a rejected user through the validity verification result of the payment method information. Therefore, if the same payment method information as that of the rejected user is received later through the receiving unit 210, the processing unit 230 may distinguish the rejected user and may invalidate unattended payment processing.

Also, the processing unit 230 may verify an adult status based on the transaction token received through the receiving unit 210 and of which validity is checked by the payment agency server and may verify that the user is an adult from the transaction token.

The unmanned payment processing system 200 according to an example embodiment may analyze consumption habit and pattern for each user by making, as data, information on a transaction token and a purchase behavior of a specific user stored and maintained in the database 231 and may use an analysis result to promote sales in unmanned vending machines or unmanned stores.

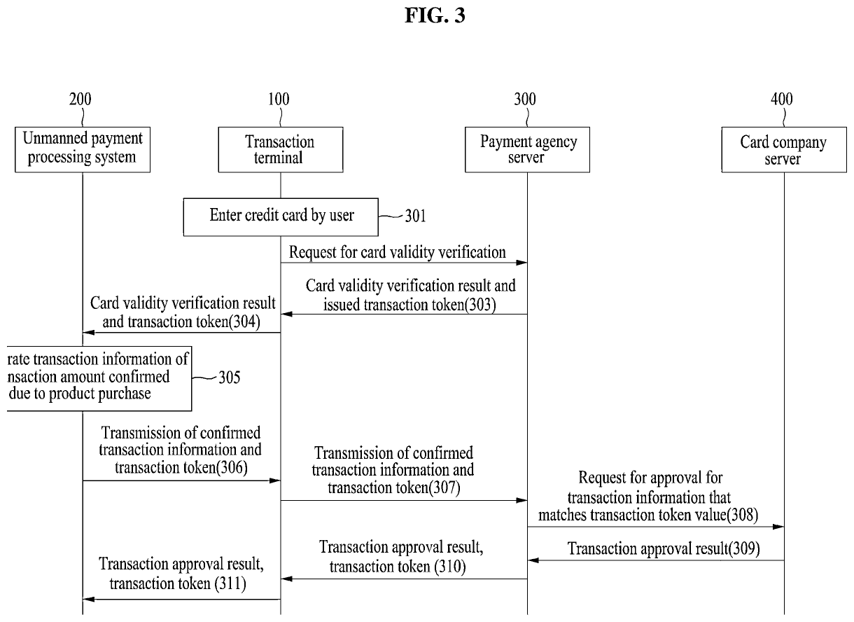

FIG. 3 illustrates a transaction approval process among a transaction terminal, an unmanned payment processing system, a payment agency server, and a card company server according to an example embodiment.

Referring to FIG. 3, in operation 301, the transaction terminal 100 receives card information by a user. For example, when the user inserts or scans a credit card, a check card, or a prepaid card into the transaction terminal 100 located in an unmanned vending machine or an unmanned store, the transaction terminal 100 may receive card transaction information, that is, payment method information in which an amount is excluded from card information on a card of the user.

Then, the transaction terminal 100 transmits the payment method information to the payment agency server 300 to request card validity verification for the payment method information in operation 302, and the payment agency server 300 transmits a card validity verification result for the payment method information and an issued transaction token to the transaction terminal 100 in operation 303.

In operation 304, the transaction terminal 100 transmits, to the unmanned payment processing system 200, the card validity verification result for the payment method information and the transaction token received from the payment agency server 300.

In operation 305, the unmanned payment processing system 200 receives the card validity verification result and the transaction token, and generates transaction information of a total transaction amount confirmed due to product purchase of the user in the unmanned vending machine or the unmanned store associated with the transaction terminal 100. Here, the unmanned payment processing system 200 may recognize an action of the user selecting a product and placing the product in a shopping cart in the unmanned vending machine or the unmanned store, may calculate a total transaction amount for the product placed in the shopping cart, and may generate transaction information.

In operation 306, the unmanned payment processing system 200 transmits, to the transaction terminal 100, the transaction token with the transaction information that includes the confirmed transaction amount. The unmanned payment processing system 200 may combine the transaction information that includes a final payment amount according to the product purchase of the user with the transaction token and may transmit the same to the transaction terminal 100. Depending on example embodiments, the transaction information may include a request for a ‘final payment’ for a final payment amount according to the product purchase of the user and may also include a request for re-approval, cancellation of approval, or a partial payment in addition to the final payment.

In operations 307 and 308, the transaction terminal 100 transmits transaction information that includes the confirmed transaction amount and the transaction token to the payment agency server 300, and the payment agency server 300 transmits the transaction information that includes the confirmed transaction amount and the transaction token to the card company server 400 and requests approval for the transaction information that matches a transaction token value.

Here, the unmanned payment processing system 200 according to an example embodiment may request the card company server 400 for re-approval and may also verify a ratio of response delay and no-response to a total number of transaction approvals of the card company server 400 and may make an inquiry and a request.

For example, if a response to a transaction approval is delayed or absent due to a computer failure or time-out at the card company server 400, the payment agency server 300 may request the corresponding card company server 400 for re-approval after a predetermined period of time (e.g., 1 minute).

As another example, when the unmanned payment processing system 200 retransmits the transaction token value and the transaction information to the payment agency server 300, the payment agency server 300 may request the card company server 400 for re-approval.

In operation 309, the card company server 400 transmits, to the payment agency server 300, an approval result for transaction information that matches the transaction token value. Here, it is assumed that an approval indicating matching between the transaction token value and the transaction information is processed at the card company server 400.

In operations 310 and 311, the payment agency server 300 transmits, to the transaction terminal 100, the transaction token with the transaction approval result received from the card company server 400 and the transaction terminal 100 transmits the transaction approval result and the transaction token to the unmanned payment processing system 200.

In operation 312, the unmanned payment processing system 200 combines the transaction information with the transaction token and processes the payment. Here, the unmanned payment processing system 200 may perform and manage a final payment, re-approval, cancellation of approval, or a partial payment for the approved transaction information based on the transaction approval result for the transaction information.

The systems or the apparatuses described herein may be implemented using hardware components, software components, and/or combinations thereof. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be permanently or temporarily embodied in any type of machine, component, physical equipment, virtual equipment, a computer storage medium or device, or a signal wave to be transmitted, to be interpreted by the processing device or to provide an instruction or data to the processing device. The software also may be distributed over network coupled computer systems so that the software is stored and executed in a distributed fashion. The software and data may be stored by one or more computer readable storage media.

The methods according to the example embodiments may be configured in a form of program instructions performed through various computer devices and recorded in non-transitory computer-readable media. The media may also include, alone or in combination with the program instructions, data files, data structures, and the like. The program instructions recorded in the media may be specially designed and configured for the example embodiments or may be known to those skilled in the computer software art and thereby available. Examples of the media include magnetic media such as hard disks, floppy disks, and magnetic tapes: optical media such as CD-ROM and DVDs; magneto-optical media such as floptical disks; and hardware devices that are specially configured to store program instructions, such as read-only memory (ROM), random access memory (RAM), flash memory, and the like. Examples of program instructions include both machine code, such as produced by a compiler, and files containing higher level code that may be executed by the computer using an interpreter. The hardware device may be configured to operate as at least one software module, or vice versa.

While the example embodiments are described with reference to specific example embodiments and drawings, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other example embodiments, and equivalents of the claims are to be construed as being included in the claims.

What is claimed is:

1. An unmanned payment processing system to communicate with a transaction terminal, the unmanned payment processing system comprising:
a receiving unit configured to receive, from the transaction terminal, payment method information and transaction information verified and approved by a payment agency server and a transaction token issued from the payment agency server;
a transaction information providing unit configured to provide, to the transaction terminal, the transaction information of a confirmed transaction amount according to a product purchase of a user; and
a processing unit configured to process a payment by combining the transaction information with the transaction token.

2. The unmanned payment processing system of claim 1, wherein the receiving unit is configured to request the transaction terminal for the transaction token issued from the payment agency server with a validity verification result for the payment method information.

3. The unmanned payment processing system of claim 2, wherein the receiving unit is configured to receive, from the transaction terminal, the transaction token issued from the payment agency server with the validity verification result for the payment method information verified by the payment agency server and to receive, from the transaction terminal, a transaction approval result for the transaction information approved by a card company server.

4. The unmanned payment processing system of claim 1, wherein the transaction information providing unit is configured to transmit, to the transaction terminal, the transaction information of a total transaction amount confirmed due to the purchase product of the user in an unmanned store associated with the transaction terminal with the transaction token.

5. The unmanned payment processing system of claim 4, wherein the transaction information providing unit is configured to verify an adult status through information of the transaction token and, when a product purchased by the user in the unmanned store associated with the transaction terminal is a product allowed to be purchased only by an adult, control provision of the transaction information depending on a selling status.

6. The unmanned payment processing system of claim 3, wherein the processing unit is configured to process a final payment, re-approval, cancelation of approval, or a partial payment for the approved transaction information based on the transaction approval result of the transaction information by the card company server.

7. The unmanned payment processing system of claim 1, wherein the processing unit is configured to invalidate unattended payment processing by managing a rejected user according to a validity verification result for the payment method information.

8. A transaction approval system comprising:
a transaction terminal configured to receive payment method information and transaction information from a user, to transmit the same to a payment agency server, and to transmit a transaction token issued from the payment agency server, a verification result, and an approval result to an unmanned payment processing system;
the payment agency server configured to perform validity verification for the payment method information, to issue the transaction token, and to request a card company server for approving a transaction that matches the transaction token; and
the unmanned payment processing system configured to receive, from the transaction terminal, the transaction token with the payment method information and the transaction information verified and approved by the payment agency server and to process a payment.

9. The transaction approval system of claim 8, wherein the transaction terminal is configured to receive the payment method information by a credit card of the user, to request the payment agency server for the validity verification, and to transmit a validity verification result and the transaction token to the unmanned payment processing system.

10. The transaction approval system of claim 9, wherein the transaction terminal is configured to receive the transaction information of a confirmed transaction amount from the unmanned payment processing system, to transmit the transaction information and the transaction token to the payment agency server, to receive a transaction approval result from the payment agency server, and to transmit the same to the unmanned payment processing system.

11. The transaction approval system of claim 10, wherein the payment agency server is configured to transmit the transaction information and the transaction token to the card company server to request approval of a transaction that matches the transaction token, and to transmit the transaction approval result from the card company server to the transaction terminal.

12. The transaction approval system of claim 8, wherein the unmanned payment processing system is configured to process a final payment, re-approval, cancelation of approval, or a partial payment for the approved transaction information based on a validity verification result for the payment method information and a transaction approval result of the transaction information by the card company server.

13. A transaction approval method of a transaction approval system by a transaction terminal, an unmanned payment processing system, and a payment agency server, the transaction approval method comprising:
transmitting, by the transaction terminal, payment method information input from a user;
performing, by the payment agency server, validity verification for the payment method information received from the transaction terminal and issuing a transaction token;
confirming, by the unmanned payment processing system, transaction information that includes a payment amount according to a product purchase of the user; and
processing, by the unmanned payment processing system, a payment for the transaction information based on an approval result for the transaction information by a card company server.

14. The transaction approval method of claim 13, wherein the issuing of the transaction token comprises transmitting a validity verification result for the payment method information and the transaction token to the unmanned payment processing system through the transaction terminal.

15. The transaction approval method of claim 13, wherein the confirming of the transaction information comprises combining the transaction information of a transaction amount confirmed due to a product purchase of the user with the transaction token and transmitting the same to the payment agency server through the transaction terminal.

16. The transaction approval method of claim 15, wherein the confirming of the transaction information comprises requesting, by the payment agency server, the card company server for approving the transaction information that matches a transaction token value.

17. The transaction approval method of claim 13, wherein the processing of the payment comprises processing, by the unmanned payment processing system, a final payment, re-approval, cancelation of approval, or a partial payment for the approved transaction information based on the approval result for the transaction information from the card company server.
